(19) United States
(12) Patent Application Publication
(10) Pub. No.: US 2014/0233267 A1
(43) Pub. Date: Aug. 21, 2014

(54) POWER CONVERTER AND METHOD OF CONVERTING POWER

(71) Applicant: DELTA ELECTRONICS, INC., Taoyuan Hsien (TW)

(72) Inventors: Hong-Yuan JIN, TAOYUAN HSIEN (TW); Jun LIU, TAOYUAN HSIEN (TW); De-Zhi JIAO, TAOYUAN HSIEN (TW)

(73) Assignee: DELTA ELECTRONICS, INC., Taoyuan Hsien (TW)

(21) Appl. No.: 14/053,336

(22) Filed: Oct. 14, 2013

(30) Foreign Application Priority Data
Feb. 20, 2013 (CN) 201310054797.9
Aug. 2, 2013 (CN) 201310334874.6

(51) Int. Cl. H02M 3/335

(52) U.S. Cl. CPC H02M 3/33507
USPC 363/21.02

(57) ABSTRACT

A power converter and a method of converting power are provided. The power converter includes a resonant converting circuit and a control circuit. The resonant converting circuit converts an input power into an output power, and provides the output power to a load. The control circuit receives a feedback signal corresponding to the output power and the load, and outputs a driving signal according to the feedback signal to drive the resonant converting circuit. The control circuit selectively adjusts a duty period and an operating frequency of the driving signal according to a power required by the load.

### RELATED APPLICATIONS

This application claims priority to China Application Serial Number 201310054797.9, filed Feb. 20, 2013, and China Application Serial Number 201310334874.6, filed on Aug. 2, 2013, which are herein incorporated by reference.

### BACKGROUND

1. Technical Field

The present invention relates to a power converter, and more particularly, to a power converter that is capable of adjusting a duty period and an operating frequency.

2. Description of Related Art

With the broad application of medical imaging instruments (e.g., x-ray machines) in a variety of different disciplines, such as in medical science, life science, and nondestructive testing, and with the use of high voltage power in X-ray machines, the requirements with respect to X-ray machine power with a high switch frequency and wide output voltage range are continuously increasing, so as to be suitable for various imaging needs. In particular, a power supply with a high switch frequency can function to reduce the size and weight of X-ray machines, and reduce ripples (or pulses) in output voltage, such that high-quality X-rays are output and output dosage is increased, and moreover, a power supply with wide output voltage range can be suitable for imaging requirements associated with different types of people and different parts of the body.

In order to realize such a power supply having a wide output voltage range, a conventional control method for a power circuit is realized using frequency control, which involves adjusting switch frequency to control output voltage to undergo changes in a relatively wide range, thereby satisfying the requirement of wide output voltage range.

However, when the output voltage is relatively low, the ripples (or pulses) of the output voltage are somewhat large, such that the precision of imaging is low, reducing image quality. Moreover, this results in an increase in the output of soft rays by the X-ray machine, such that the patient is exposed to more radiation.

Hence, it is evident that existing power sources still have problems and defects associated therewith, and improvements are needed. There has been much effort put forth by those in related fields in order to solve the above-described problems. However, no suitable method has been developed as of yet.

### SUMMARY

Accordingly, at least one exemplary embodiment may provide a power converter. The power converter according to this embodiment may comprise a resonant converting circuit which converts an input power into an output power, and provides the output power to a load; and a control circuit which receives a feedback signal corresponding to the output power and the load, and outputs a driving signal according to the feedback signal to drive the resonant converting circuit. The control circuit selectively adjusts a duty period and an operating frequency of the driving signal according to a power required by the load.

In some embodiments, the control circuit simultaneously adjusts the duty period and the operating frequency of the driving signal according to changes in the power required by the load.

In some embodiments, the control circuit simultaneously adjusts the duty period and the operating frequency of the driving signal in a manner proportional to changes in the power required by the load.

In some embodiments, when the amount of power required by the load is larger than a predetermined level, the control circuit fixes the operating frequency of the driving signal and adjusts the duty period of the driving signal according to changes in the power required by the load.

In some embodiments, when the amount of power required by the load is smaller than a predetermined level, the control circuit fixes the duty period of the driving signal and adjusts the operating frequency of the driving signal according to changes in the power required by the load.

In some embodiments, when the amount of power required by the load is larger than a predetermined level, according to changes in the power required by the load, the control circuit adjusts the duty period of the driving signal and slightly adjusts the operating frequency of the driving signal.

In some embodiments, when the amount of power required by the load is smaller than a predetermined level, according to changes in the power required by the load, the control circuit adjusts the operating frequency of the driving signal and slightly adjusts the duty period of the driving signal.

In some embodiments, when the amount of power required by the load is approximately equal to a predetermined level, the control circuit adjusts the duty cycle of the driving signal to approximately 0.01-0.05.

In some embodiments, when the amount of power required by the load is approximately equal to a predetermined level, the control circuit adjusts the duty cycle of the driving signal to approximately 0.01-0.5.

In some embodiments, the control circuit selectively adjusts the duty period and the operating frequency of the driving signal by receiving a feedback voltage signal corresponding to an output voltage generated by the resonant converting circuit or by receiving a feedback current signal corresponding to an output current generated by the resonant converting circuit.

In some embodiments, the resonant converting circuit comprises at least one switch unit which is controlled by the driving signal to be alternatingly turned on and turned off so as to transmit the input power; a resonant unit electrically coupled to the at least one switch unit, the resonant unit and the at least one switch unit cooperating to generate an AC power; an isolation unit electrically coupled to the resonant unit, the isolation unit realizing electrical isolation and transmitting the AC power to output a secondary output power; and a rectifying unit electrically coupled to the isolation unit, the rectifying unit rectifying the secondary AC power and generating the output power, the rectifying unit transmitting the output power to the load.

In another exemplary embodiment, a method of converting power may be provided. The method of converting power according to this embodiment may comprise converting, by a resonant converting circuit, an input power into an output power, and providing, by the resonant converting circuit, the output power to a load; receiving, by a control circuit, a feedback signal corresponding to the output power and the load; outputting, by the control circuit, a driving signal according to the feedback signal to drive the resonant converting circuit; and selectively adjusting, by the control circuit, a duty period and an operating frequency of the driving signal according to a power required by the load.

In some embodiments, selectively adjusting, by the control circuit, the duty period and the operating frequency of the driving signal according to the power required by the load comprises simultaneously adjusting the duty period and the operating frequency of the driving signal according to changes in the power required by the load.

In some embodiments, selectively adjusting, by the control circuit, the duty period and the operating frequency of the driving signal according to the power required by the load comprises simultaneously adjusting the duty period and the operating frequency of the driving signal in a manner proportional to changes in the power required by the load.

In some embodiments, selectively adjusting, by the control circuit, the duty period and the operating frequency of the driving signal according to the power required by the load comprises when the amount of power required by the load is larger than a predetermined level, fixing the operating frequency of the driving signal and adjusting the duty period of the driving signal according to changes in the power required by the load.

In some embodiments, selectively adjusting, by the control circuit, the duty period and the operating frequency of the driving signal according to the power required by the load comprises when the amount of power required by the load is smaller than a predetermined level, fixing the duty period of the driving signal and adjusting the operating frequency of the driving signal according to changes in the power required by the load.

In some embodiments, selectively adjusting, by the control circuit, the duty period and the operating frequency of the driving signal according to the power required by the load comprises when the amount of power required by the load is larger than a predetermined level, adjusting the duty period of the driving signal and slightly adjusting the operating frequency of the driving signal according to changes in the power required by the load.

In some embodiments, selectively adjusting, by the control circuit, the duty period and the operating frequency of the driving signal according to the power required by the load comprises when the amount of power required by the load is smaller than a predetermined level, adjusting the operating frequency of the driving signal and slightly adjusting the duty period of the driving signal according to changes in the power required by the load.

In some embodiments, selectively adjusting, by the control circuit, the duty period and the operating frequency of the driving signal according to the power required by the load comprises when the amount of power required by the load is approximately equal to a predetermined level, adjusting the duty cycle of the driving signal to approximately 0.01-0.05.

In some embodiments, selectively adjusting, by the control circuit, the duty period and the operating frequency of the driving signal according to the power required by the load comprises when the amount of power required by the load is approximately equal to a predetermined level, adjusting the duty cycle of the driving signal to approximately 0.01-0.5.

In some embodiments, receiving, by the control circuit, the feedback signal corresponding to the output power and the load comprises receiving a feedback voltage signal corresponding to an output voltage generated by the resonant converting circuit, or receiving a feedback current signal corresponding to an output current generated by the resonant converting circuit.

In some embodiments, converting, by the resonant converting circuit, the input power into the output power, and providing, by the resonant converting circuit, the output power to the load comprises controlling at least one switch unit of the resonant converting circuit according to the driving signal to be alternatingly turned on and turned off so as to transmit the input power; generating, through cooperation of a resonant unit of the resonant converting circuit and the at least one switch unit, an AC power; realizing electrical isolation and transmitting the AC power to output a secondary output power by an isolation unit of the resonant converting circuit; and rectifying the secondary AC power and generating the output power by a rectifying unit of the resonant converting circuit, and transmitting the output power to the load by the rectifying unit.

As is evident from the above, compared to existing techniques, in the present invention, the operating frequency and the duty period of the driving signal is selectively adjusted, providing greater flexibility with respect to the manner in which power is converted, such that it is possible to satisfy the requirements with respect to different types of loads. Moreover, by selectively adjusting the duty period and the operating frequency of the driving signal, the resonant converting circuit can be made to output an output voltage with a small ripple, such that the power quality of an X-ray machine is enhanced, ultimately increasing the efficiency of an imaging machine, improving the precision and quality of imaging, and reducing the output of soft rays by an X-ray machine.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a schematic circuit diagram of a power converter according to an embodiment of the present invention;

FIG. 2 shows waveform diagrams generated by the power converter of FIG. 1 according to an embodiment of the present invention;

FIG. 3 shows waveform diagrams of output current and output voltage shown in FIG. 1 according to an embodiment of the present invention;

FIG. 4 shows waveform diagrams generated by the power converter of FIG. 1 according to another embodiment of the present invention;

FIG. 5A is a load to duty period curve according to an embodiment of the present invention;

FIG. 5B is a load to operating frequency curve according to an embodiment of the present invention;

FIG. 6 shows a load to duty period curve and a load to operating frequency curve according to another embodiment of the present invention;

FIG. 7 shows a load to duty period curve and a load to operating frequency curve according to yet another embodiment of the present invention; and

FIG. 8 shows waveform diagrams of output current and output voltage shown in FIG. 1 according to another embodiment of the present invention.

### DETAILED DESCRIPTION

In the following description, specific details are presented to provide a thorough understanding of the embodiments of the present disclosure. Persons of ordinary skill in the art will recognize, however, that the present disclosure can be practiced without one or more of the specific details, or in combination with other components. Well-known implementations or operations are not shown or described in detail to avoid obscuring aspects of various embodiments of the present disclosure.

The terms used in this specification generally have their ordinary meanings in the art and in the specific context where each term is used. The use of examples anywhere in this specification, including examples of any terms discussed herein, is illustrative only, and in no way limits the scope and meaning of the disclosure or of any exemplified term. Likewise, the present disclosure is not limited to various embodiments given in this specification.

As used herein, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated, or meaning other approximate values.

Referring to the drawings, like numbers indicate like components throughout the views. As used in the description herein and throughout the claims that follow, the meaning of “a,” “an,” and “the” includes plural reference unless the context clearly dictates otherwise. Also, as used in the description herein and throughout the claims that follow, the terms “comprising,” “including,” “having,” “containing,” “involving,” and the like are to be understood to be open-ended, i.e., to mean including but not limited to.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

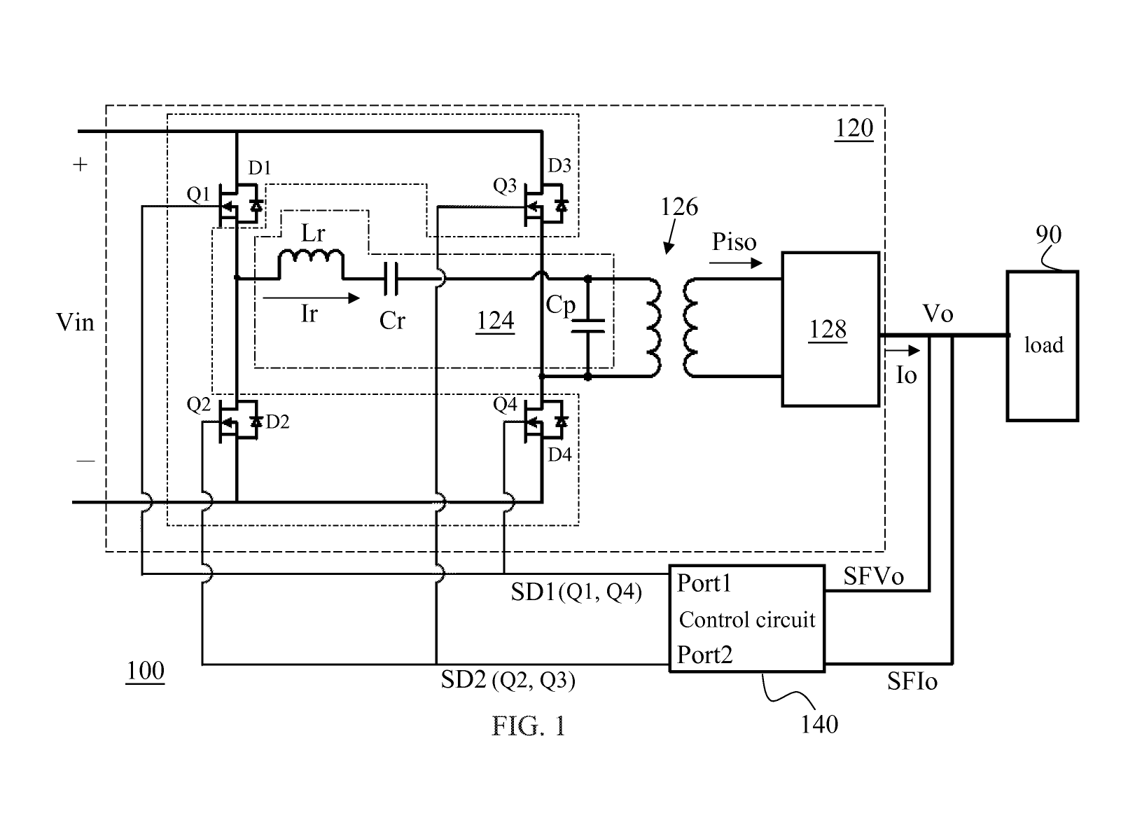

FIG. 1 is a schematic circuit diagram of a power converter according to an embodiment of the present invention. The power converter 100 comprises a resonant converting circuit 120 and a control circuit 140. The resonant converting circuit 120 converts an input power (e.g., a power corresponding to an input voltage Vin) into an output power (e.g., a power corresponding to an output voltage Vo or an output current Io), and provides the output power to a load 90 (e.g., a circuit in an X-ray machine).

The control circuit 140 receives a feedback signal corresponding to the aforementioned output power and the load 90, and outputs a driving signal according to the feedback signal to drive the resonant converting circuit 120, such that the resonant converting circuit 120 accordingly operates to convert the input power into the output power (i.e., generates the output voltage Vo and the output current Io). In this embodiment, the driving signal may include two switch driving signals SD1 and SD2 (see FIG. 1). In addition, the control circuit 140 selectively adjusts duty periods and operating frequencies of the switch driving signals SD1 and SD2 according to a power required by the load 90 (or according to the size of the load).

In some embodiments, the control circuit 140 selectively adjusts the duty periods and the operating frequencies of the switch driving signals SD1 and SD1 by receiving a feedback voltage signal SFVo corresponding to the output voltage Vo generated by the resonant converting circuit 120 or by receiving a feedback current signal SFIo corresponding to the output current Io generated by the resonant converting circuit 120.

In some embodiments, the resonant converting circuit 120 may comprise switch units Q1-Q4, a resonant unit 124, an isolation unit 126, and a rectifying unit 128.

The switch units Q1-Q4 are controlled by the switch driving signal SD1 and the switch driving signal SD2 to be alternatingly turned on and turned off, so as to transmit input power (e.g., corresponding to the power of the input voltage Vin) to the resonant unit 124. In particular, the switch units Q1, Q4 may be controlled by the switch driving signal SD1, and the switch units Q2, Q3 may be controlled by the switch driving signal SD2. The resonant unit 124 and the switch units Q1-Q4 are electrically coupled to each other and the resonant unit 124 and at least one of the switch units Q1-Q4 cooperate to generate AC (alternating current) power. The isolation unit 126 and the resonant unit 124 are electrically coupled to each other, and the isolation unit 126 realizes electrical isolation and transmits the aforementioned AC power to output a secondary AC power Piso. The rectifying unit 128 and the isolation unit 126 are electrically coupled to each other, and the rectifying unit 128 rectifies the secondary AC power Piso and generates an output power (e.g., a power corresponding to the output voltage Vo or the output current Io), and transmits the output power to the load 90.

In some embodiments, the switch units Q1-Q4 are metal-oxide-semiconductor field-effect transistors (MOSFETs) or insulated-gate bipolar transistors (IGBTs). In practice, the number of switch units in the resonant converting circuit 120 is not limited to what is shown and described above. For example, the resonant converting circuit 120 may comprise a single switch unit, two switch units, or four or more switch units. In other words, persons of ordinary skill in the art may decide on the number of switch units for the resonant converting circuit 120 as deemed necessary without departing from the spirit and scope of the present invention.

As shown in FIG. 1, the switch units Q1-Q4 form a full-bridge circuit, but the present invention is not limited in this regard. The switch units Q1-Q4 may form a half-bridge circuit, an interleaved two-transistor forward circuit, or other types of switch circuits. The switch unit Q1 and the switch unit Q2 are electrically coupled in series, and the switch unit Q3 and the switch unit Q4 are electrically coupled in series. A control terminal of each of the switch unit Q1 and the switch unit Q4 is electrically coupled to a control output terminal Port1 of the control circuit 140, and a control terminal of each of the switch unit Q2 and the switch unit Q3 is electrically coupled to a control output terminal Port2 of the control circuit 140. As a result, the switch unit Q1 and the switch unit Q4 can receive the switch driving signal SD1 to thereby be simultaneously turned on or turned off, and the switch unit Q2 and the switch unit Q3 can receive the switch driving signal SD2 to thereby be simultaneously turned on or turned off. However, the present invention is not limited in this regard. For example, the control terminals of the switch units Q1-Q4 can be electrically coupled respectively to different control output terminals, such that the control circuit 140 separately controls the switch units Q1-Q4. Moreover, the switch units Q1-Q4 may be further electrically coupled in parallel to diodes D1-D4, respectively, such that the switch units Q1-Q4 are applied to a zero current switching (ZCS) circuit. The diodes D1-D4 are internally connected diodes of the switch units Q1-Q4 or diodes connected in parallel to the switch units Q1-Q4.

One terminal of the resonant unit 124 is electrically coupled to a node between the switch unit Q1 and the switch unit Q2, and another terminal of the resonant unit 124 is electrically coupled to a node between the switch unit Q3 and the switch unit Q4. The resonant unit 124 further comprises a resonant inductor Lr, a resonant capacitor Cr, and a parasitic capacitor Cp. The parasitic capacitor Cp may be an external equivalent parasitic capacitor or a parasitic capacitor of the isolation unit 126.

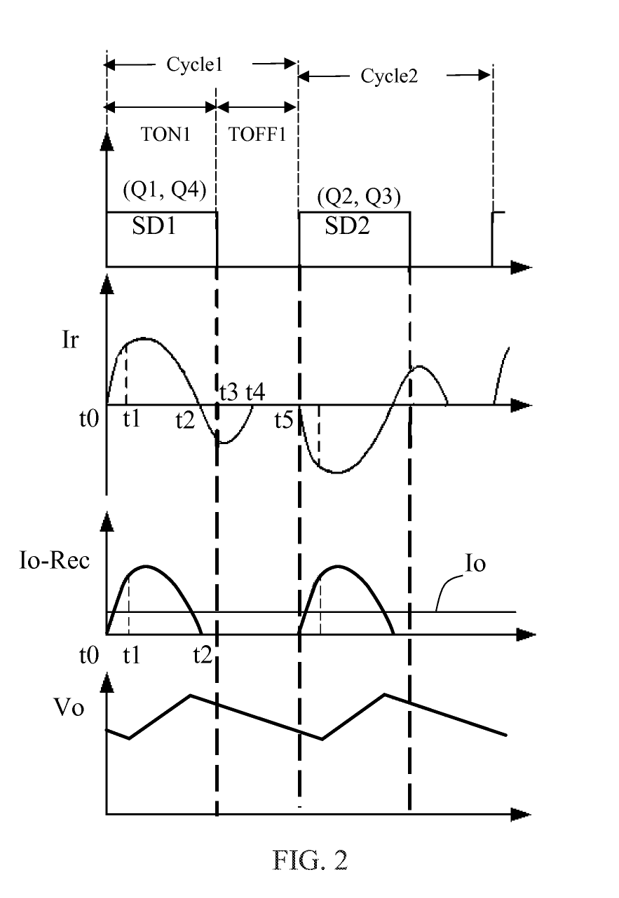

FIG. 2 shows waveform diagrams generated by the power converter 100 of FIG. 1 according to an embodiment of the present invention. The operation of the resonant converting circuit 120 will now be explained with reference to FIGS. 1 and 2. As shown in FIG. 2, the switch driving signal SD1 operates cyclically according to a duty cycle Cycle1, and alternatingly with the switch driving signal SD2, such that the switch driving signal SD2 operates cyclically according to a duty cycle Cycle2 that is connected to the rear of the duty cycle Cycle1 of the switch driving signal SD1. In the duty cycle Cycle1, the switch driving signal SD1 has a first duty period TON1, and the switch driving signal SD1 is at a high level in the duty period TON1, such that the switch unit Q1 and the switch unit Q4 are turned on during the duty period TON1 (but the present invention is not limited in this regard, and the switch driving signal SD1 may maintain a low level to turn on p-type transistors). Moreover, the switch driving signal SD1 is at a low level in the turn off period TOFF1, such that the switch unit Q1 and the switch unit Q4 are turned off in the turn off period TOFF1 (but the present invention is not limited in this regard, and the switch driving signal SD1 can maintain a high level to turn off p-type transistors).

In addition, the duty cycle Cycle1 of the switch driving signal SD1 corresponds to the operating frequency of the switch driving signal SD1. For example, the duty cycle Cycle1 is inversely proportional to the operating frequency, such that when the control circuit 140 is adjusting the operating frequency of the switch driving signal SD1, the duty cycle Cycle1 is correspondingly adjusted by the control circuit 140.

It is noted that characteristics and the relationship between the switch driving signal SD2 and the duty cycle Cycle2 are similar to the description given above, and so an explanation in this regard will not be given.

The switch driving signal SD1 and the switch driving signal SD2 operate alternatingly, such that the switch units Q1, Q4 and the switch units Q2, Q3, alternatingly operate. To simplify the explanation, the switch units Q1 and Q4 shown in FIG. 1 and the timing diagram shown in FIG. 2 will be described in the following. However, it is to be understood that the operation of the remaining switch units is analogous to the description to be given below.

First, at time t0-t1, the switch driving signal SD1 changes to a high level, and the switch driving signal SD1 controls the switch unit Q1 and the switch unit Q4 to conduct, such that an input power (e.g., an input power corresponding to the input voltage Vin or the input current) is transmitted to the resonant unit 124. As a result, the parasitic capacitor Cp in the resonant unit 124 is charged. At this time, current flows through the switch unit Q1, the resonant inductor Lr, the resonant capacitor Cr, the parasitic capacitor Cp, and the switch unit Q4, such that the resonant inductor Lr, the parasitic capacitor Cp, and the resonant capacitor Cr undergo resonance.

Next, at time t1, the parasitic capacitor Cp is fully charged, such that the resonant inductor Lr and the resonant capacitor Cr undergo resonance. For example, the isolation unit 126 may be an isolation transformer, and a resonant current Ir flows to a primary winding of the isolation transformer, such that the resonant unit 124 and the switch units Q1, Q4 cooperate to form a forward portion of an AC power, and the isolation unit 126 transmits the AC power to output the AC power Piso of the secondary winding.

The rectifying unit 128 performs rectification with respect to the AC power Piso of the secondary winding to generate a rectifying current Io-Rec (see FIG. 2). After undergoing subsequent processing, the rectifying current Io-Rec is formed into a DC (direct current) output current Io, and the output voltage Vo is correspondingly generated. The output current Io is an average value of the current Io-Rec.

Next, at time t2, the switch driving signal SD1 is maintained at the high level, and the resonant current Ir becomes zero, as does the current of the secondary winding of the isolation unit 126, such that the output current of the rectifying unit 128 becomes zero.

Subsequently, at time t2-t3, the resonant current Ir flows in the opposite direction, and the resonant current Ir flows from the switch unit Q4, and passes through the parasitic capacitor Cp, the resonant capacitor Cr, and the resonant inductor Lr, and toward the switch unit Q1, such that the resonant inductor Lr, the resonant capacitor Cr, and the parasitic capacitor Cp resonate.

At time t3, the switch driving signal SD1 changes to a low level to thereby control the switching unit Q1 and the switch unit Q4 to turn off. At this time, the resonant current Ir passes through the diode D1 and the diode D4, so as to realize a zero current switching operation.

Next, at time t4, the switch driving signal SD1 is maintained at a low level, the resonant current Ir becomes zero, and the operation of the switch unit Q1 and the switch unit Q4 is finished.

On the other hand, as shown in FIG. 2, the resonant current Ir that passes through the switch unit Q2 and the switch unit Q3, and the resonant current Ir that passes through the switch unit Q1 and the switch unit Q4 are opposite in phase, such that the resonant unit 124 and the switch units Q1, Q2, Q3, and Q4 cooperate to generate an AC power corresponding to the resonant current Ir. The operations of the switch unit Q2 and the switch unit Q3 are similar to the operations of the switch unit Q1 and the switch unit Q4, and therefore, a description in this regard will not be provided.

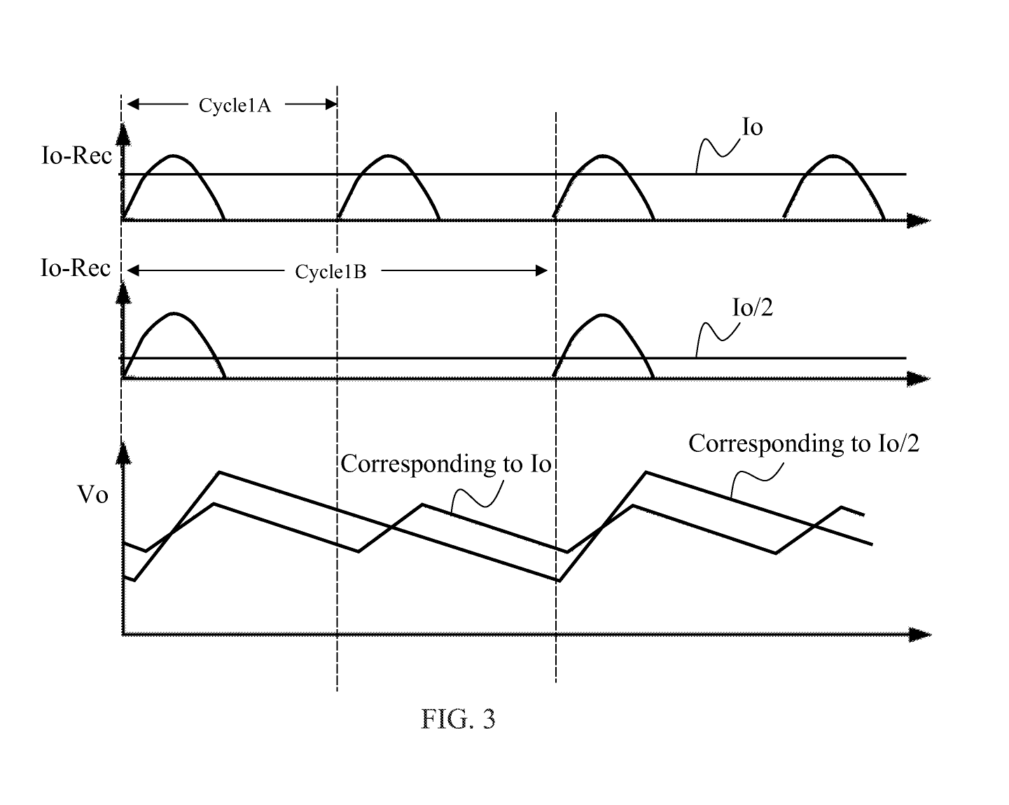

As is evident from the above, when output voltage is reduced, since the energy transmitted from the primary side to the secondary side of the transformer in each switch cycle is maintained and does not change, the pulse of the output voltage (ΔVo) increases, such that the ripple of the output voltage (ΔVo/Vo) correspondingly increases, thereby affecting the imaging quality. In addition, when the load is reduced, the power required thereby is also reduced. As a result, assuming that the voltage needed by the load is fixed, the output current is reduced, such that the ripple of the output voltage correspondingly increases, similarly affecting imaging quality. FIG. 3 shows waveform diagrams of output current and output voltage shown in FIG. 1 according to an embodiment of the present invention. As shown in FIG. 3, when the load is reduced, assuming that the voltage needed by the load is fixed, the output current Io is reduced to Io/2, such that the ripple of the output voltage Vo corresponding to the output current Io/2 is larger than the ripple of the output voltage Vo corresponding to the output current Io, thereby affecting imaging quality.

In order to solve these problems, the control circuit 140 shown in FIG. 1 can selectively adjust the duty periods and the operating frequencies of the switch driving signals SD1 and SD2 according to the power required by the load 90. As a result, when the load 90 changes, the ripple of the output voltage Vo of the power converter 100 does not noticeably increase. Hence, the power converter 100 is able to flexibly cope with various load requirements.

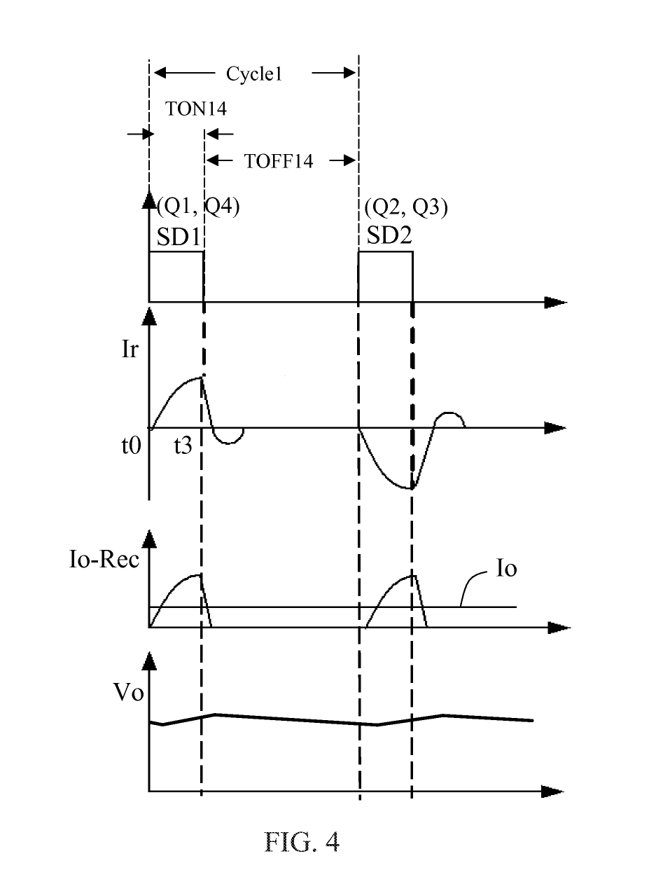

FIG. 4 shows waveform diagrams generated by the power converter 100 of FIG. 1 according to another embodiment of the present invention. Compared to FIG. 2, the control circuit 140 selectively adjusts the duty periods and the operating frequencies of the switch driving signals SD1 and SD2 according to the power required by the load 90. For example, in a state where the load 90 is reduced, and it is necessary to maintain the output voltage Vo while changing the output current Io, the control circuit 140 adjusts the duty period TON14 of the switch driving signal SD1 (i.e., the conducting period of the switch unit Q1 and the switch unit Q4) to be smaller than the duty period TON1 as shown in FIG. 2, such that the energy transmitted from the primary side to the second side of the transformer in one switch cycle is reduced, the output current Io is smaller than the output current as shown in FIG. 2, and the ripple of the output voltage Vo is smaller than the ripple of the output voltage Vo shown in FIG. 2. The control circuit 140 similarly adjusts the duty period of the switch driving signal SD2, and hence, a description in this regard will not be provided.

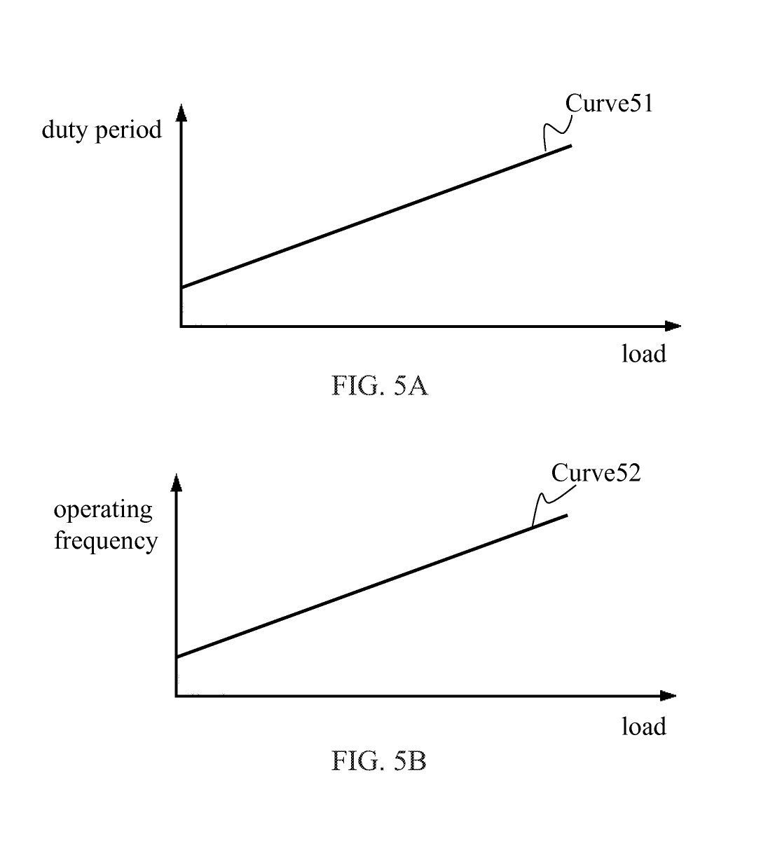

FIG. 5A is a load to duty period curve according to an embodiment of the present invention. As shown in FIG. 1 and FIG. 5A, the control circuit 140 can independently adjust the duty periods of the switch driving signals SD1 and SD2 according to the size of the load 90 (or the amount of power required by the load 90), such that the duty periods of the switch driving signals SD1 and SD2 vary in a manner proportional to the size of the load 90 (or the amount of power required by the load 90), such as shown by curve Curve51.

FIG. 5B is a load to operating frequency curve according to an embodiment of the present invention. Similar to the situation described above, as shown in FIG. 1 and FIG. 5B, the control circuit 140 can independently adjust the operating frequencies of the switch driving signals SD1 and SD2 according to the size of the load 90 (or the amount of power required by the load 90), such that the operating frequencies of the switch driving signals SD1 and SD2 vary in a manner proportional to the size of the load 90 (or the amount of power required by the load 90), such as shown by curve Curve52.

Moreover, the duty periods and the operating frequencies of the aforementioned driving signals may be simultaneously adjusted. In other words, the control circuit 140 can simultaneously adjust the duty periods and the operating frequencies of the switch drive signals SD1 and SD2 according to changes in the power required by the load 90. In some embodiments, the control circuit 140 simultaneously adjusts the duty periods and the operating frequencies of the switch driving signals SD1 and SD2 in a manner proportional to changes in the power required by the load 90 (e.g., in a varying manner as shown by curve Curve51 and curve Curve52).

Additionally, it is not necessary to adjust the operating frequencies and the duty periods by the same amount, and it may be possible to adjust the operating frequencies mainly and slightly adjust the duty periods, or adjust the duty periods mainly and only slightly adjust the operating frequencies.

It is to be noted that the curve Curve51 corresponding to duty period and the curve Curve52 corresponding to operating frequency can have different slopes, such that the power converter 100 is able to output the output voltage Vo with a relatively low ripple, and to selectively either simultaneously or separately adjust duty period and operating frequency, all within the power required by the load 90, thereby allowing the power converter 100 to operate in a more flexible manner.

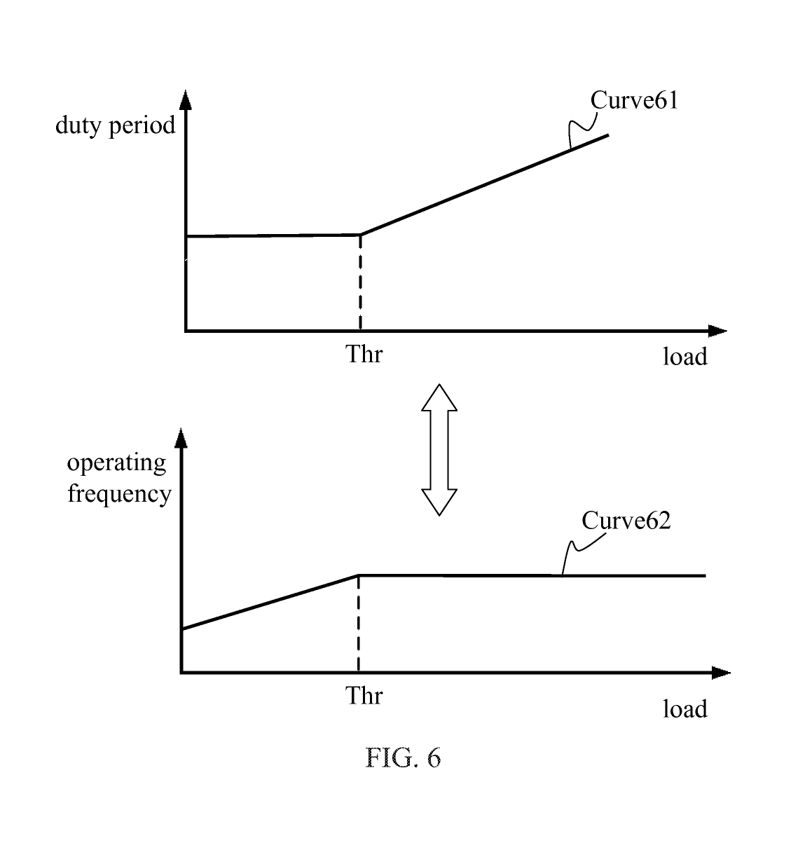

FIG. 6 shows a load to duty period curve and a load to operating frequency curve according to another embodiment of the present invention. In contrast to FIG. 5A and FIG. 5B, in this embodiment, when the load 90 is somewhat large or larger than a predetermined level Thr (i.e., the amount of power required by the load 90 is larger than a predetermined level), the slope of curve Curve62 of operating frequency to load 90 (or the power required) is zero. That is, the control circuit 140 fixes the operating frequencies of the switch driving signals SD1 and SD2, and adjusts the duty periods of the switch driving signals SD1 and SD2 according to a curve Curve61 that varies with the load 90 (or the power required). As a result, after the duty periods of the switch driving signals SD1 and SD2 are adjusted, the switch driving signals SD1 and SD2 are able to drive the switch units Q1-Q4 in the resonant converting circuit 120 according to changes in the load 90 to thereby obtain an output voltage Vo with a relatively low ripple.

Furthermore, when the load 90 is somewhat small or smaller than the predetermined level Thr (i.e., the amount of power required by the load 90 is smaller than a predetermined level), the slope of the curve Curve61 of duty period to load 90 (or the power required) is zero. That is, the control circuit 140 fixes the duty periods of the switch driving signals SD1 and SD2, and adjusts the operating frequencies of the switch driving signals SD1 and SD2 according to the curve Curve62 that varies with the load 90 (or the power required). As a result, after the operating frequencies of the switch driving signals SD1 and SD2 are adjusted, the switch driving signals SD1 and SD2 are able to drive the switch units Q1-Q4 in the resonant converting circuit 120 according to changes in the load 90 to thereby obtain an output voltage Vo with a relatively low ripple.

It is to be noted that in practice, when the load is relatively small, the duty period approaches a minimum value and is not able to undergo large variations due to the limitations of the power system (the duty period is only able to be adjusted to a predetermined minimum value), and in turn, the operating frequency is adjusted to thereby conform to changes in load.

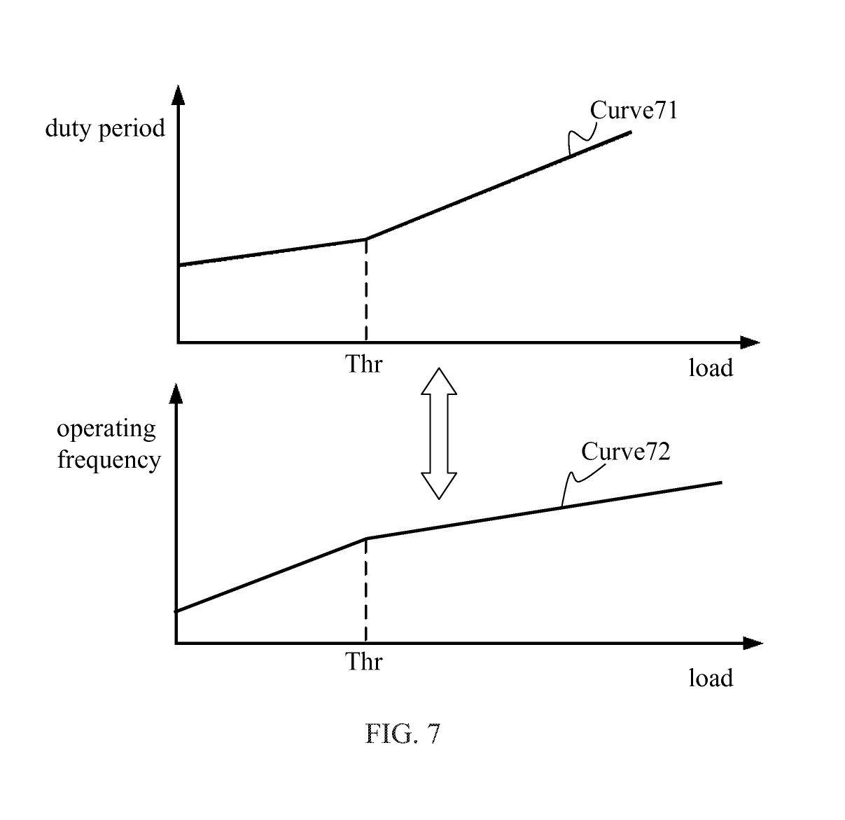

FIG. 7 shows a load to duty period curve and a load to operating frequency curve according to yet another embodiment of the present invention. Compared to FIG. 6, in this embodiment, when the load 90 is somewhat large or larger than a predetermined level Thr (i.e., the amount of power required by the load 90 is larger than a predetermined level), the control circuit 140 adjusts the duty periods of the switch driving signals SD1 and SD2, and slightly adjusts the operating frequencies of the switch driving signal SD1 and the switch driving signal SD2 according to changes in the load 90 (or the power required).

In this embodiment, the control circuit 140 adjusts duty period according to a curve Curve71, and slightly adjusts operating frequency according to a curve Curve72. In other words, when the load 90 is larger than the predetermined level Thr, the slope of the curve Curve71 is larger than the slope of the curve Curve72, such that the control circuit 140 mainly adjusts duty period according the curve Curve71 and slightly adjusts operating frequency according to the curve Curve72.

On the other hand, when the load 90 is somewhat small or smaller than the predetermined level Thr (i.e., the amount of power required by the load 90 is smaller than a predetermined level), the control circuit 140 adjusts the operating frequencies of the switch driving signals SD1 and SD2, and slightly adjusts the duty periods of the switch driving signal SD1 and the switch driving signal SD2 according to changes in the load 90 (or the power required).

In this embodiment, the control circuit 140 adjusts operating frequency according to the curve Curve72 and slightly adjusts duty period according to the curve Curve71. In other words, when the load 90 is smaller than the predetermined level Thr, the slope of the curve Curve72 is larger than the slope of the curve Curve71, such that the control circuit 140 adjusts operating frequency according the curve Curve72 and slightly adjusts duty period according to the curve Curve71.

Similar to the previous embodiment, when the load is relatively small, the duty period approaches a minimum value and is not able to undergo large variations due to the limitations of the power system (the duty period is only able to be adjusted to a predetermined minimum value), and in turn, the operating frequency is adjusted, thereby conforming to changes in load.

In the embodiments described with reference to FIGS. 6 and 7, when the size of the load 90 is approximately equal to the predetermined level Thr (or the power required thereby is approximately equal to the predetermined level Thr), the control circuit 140 adjusts the duty cycles of the switch driving signals SD1 and SD2 to approximately 0.01-0.5. In some embodiment, when the size of the load 90 is approximately equal to the predetermined level Thr (or the power required thereby is approximately equal to the predetermined level Thr), the control circuit 140 adjusts the duty cycles of the switch driving signals SD1 and SD2 to approximately 0.01-0.05. It is noted that the aforementioned predetermined level Thr may be set according to the minimum value of the duty period at the limit of the power system, but the present invention is not limited in this regard.

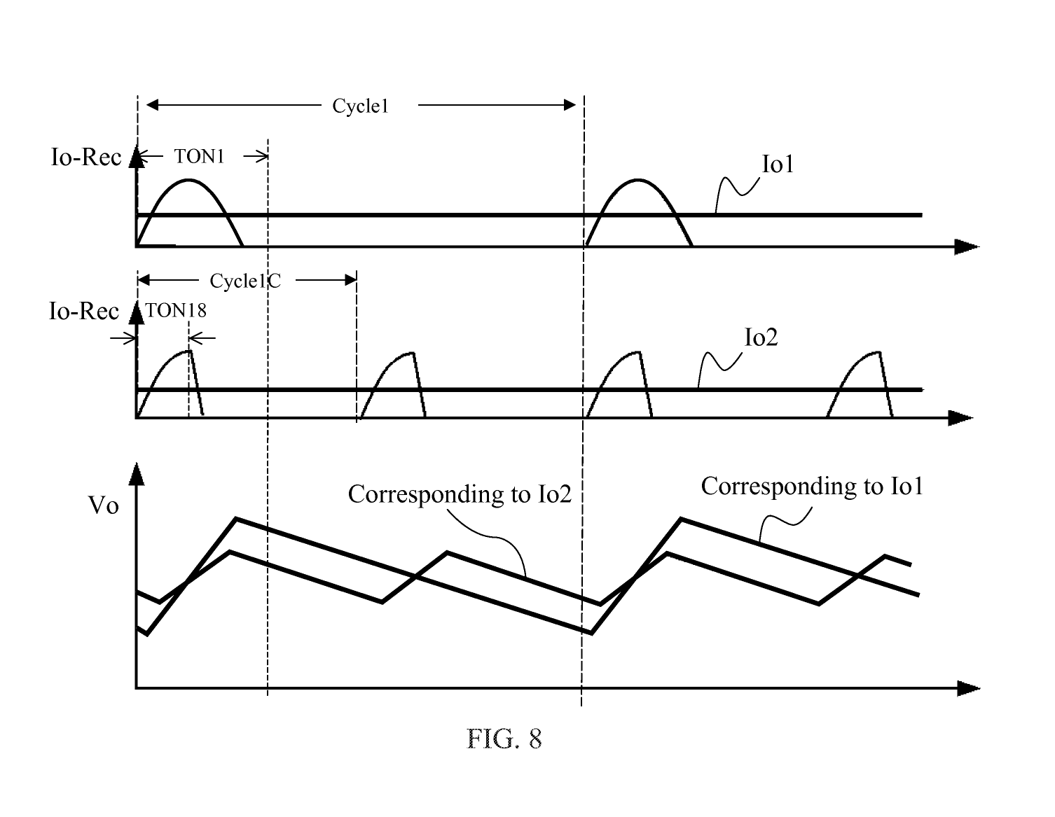

FIG. 8 shows waveform diagrams of output current and output voltage shown in FIG. 1 according to another embodiment of the present invention. As shown in FIG. 8, when the load is small, if only operating frequency is adjusted, the rectifying current Io-Rec is as shown, the output current is Io1, and the output voltage Vo corresponding to the output current Io1 has a relatively large ripple. On the other hand, if operating frequency and duty period are adjusted as described above, the rectifying current Io-Rec is as shown, the output current is Io2, and the output voltage Vo corresponding to the output current Io2 has a comparatively small ripple. Therefore, an imaging machine (e.g., an X-ray machine) has a better power quality, such that the efficiency thereof is improved.

As is evident from the aforementioned embodiments, through application of the techniques of the prevent invention, operating frequency and duty period of driving signals are selectively adjusted, such the output of the power converter is able to satisfy the requirements of different types of loads. Moreover, by adjusting duty period of driving signals, the ripple of the output voltage of the power converter can be made relatively small, thereby enhancing the power quality of an X-ray machine, ultimately increasing the efficiency of an imaging machine.

Another aspect of the present invention relates to a method of converting power, which may be applied to the power converter 100 of FIG. 1, but the present invention is not limited in this regard. A method of converting power applied to the power converter 100 of FIG. 1 will now be described. First, an input power (e.g., an input power corresponding to an input voltage Vin and an input current) is converted by the resonant converting circuit 120 into an output power (e.g., an output power corresponding to an output voltage Vo and an output current Io), and the output power is provided to a load 90. Next, a feedback signal corresponding to the aforementioned output power and the load 90 is received by the control circuit 140. Subsequently, a driving signal according to the feedback signal is output by the control circuit 140 to drive the resonant converting circuit 120. The driving signal may include the switch driving signals SD1 and SD2 (see FIG. 1). Subsequently, the duty periods and the operating frequencies of the switch driving signals SD1 and SD2 are adjusted by the control circuit 140 according to a power required by the load 90 (or according to the size of the load 90). Therefore, the adjusted switch driving signals SD1 and SD2 drive the resonant converting circuit 120, such that the resonant converting circuit 120 is controlled to adjust the output power.

In some embodiments, the feedback signal received by the control circuit 140 is a feedback voltage signal SFVo corresponding to the output voltage Vo generated by the resonant converting circuit 120, or is a feedback current signal SFIo corresponding to the output current Io generated by the resonant converting circuit 120, as shown in FIG. 1.

In some embodiments, converting the input power into an output power and transmitting the output power to the load 90 further includes the following steps: controlling at least one of the switch units Q1-Q4 by the control circuit 140 to alternatingly turn on and turn off according to the operating frequencies and the duty periods of the switch driving signals SD1 and SD2, so as to adjust and transmit the aforementioned input power to the resonant unit 124; generating an AC power through cooperation of the resonant unit 124 and at least one of the switch units Q1-Q4; realizing electrical isolation and transmitting the aforementioned AC power by the isolation unit 126 to output a secondary AC power Piso; by operation of the rectifying unit 128, rectifying the secondary AC power Piso and generating an output power (e.g., a power corresponding to the output voltage Vo or the output current Io), and transmitting the output power to the load 90.

The operation of the switch units Q1-Q4 may be performed by the control unit 140 using the embodiments described with reference to FIGS. 2-4, and the duty periods and the operating frequencies of the switch driving signals SD1 and SD2 may be adjusted using the embodiments described with reference to FIGS. 5A-7, such that the switch driving signals SD1 and SD2 control the switch units Q1-Q4 after having been adjusted. Details with respect to such control and adjustment are as described above, and therefore will not be repeated.

As shown in FIGS. 5A and 5B, in some embodiments, selectively adjusting the duty periods and the operating frequencies of the switch driving signals SD1 and SD2 according to the power required by the load 90 may include the following step: simultaneously or independently adjusting the duty periods and operating frequencies of the switch driving signals SD1 and SD2 by the control unit 140 according to changes in the power required by the load 90 (or the size of the load 90) in a manner corresponding to the curve Curve51 (related to duty period) and curve Curve52 (related to operating frequency).

In some embodiments, selectively adjusting the duty periods and the operating frequencies of the switch driving signals SD1 and SD2 according to the power required by the load 90 may include the following step: simultaneously or independently adjusting the duty periods and the operating frequencies of the switch driving signals SD1 and SD2 by the control circuit 140 in a manner proportional to changes in the power required by the load 90.

As shown in FIG. 6, in some embodiments, selectively adjusting the duty periods and the operating frequencies of the switch driving signals SD1 and SD2 according to the power required by the load 90 by the control circuit 140 may include the following step: when the load 90 is somewhat large or larger than a predetermined level Thr (i.e., the amount of power required by the load 90 is larger than a predetermined level), through operation of the control circuit 140, fixing the operating frequencies of the switch driving signals SD1 and SD2, and adjusting the duty periods of the switch driving signals SD1 and SD2 according to the curve Curve61 that varies with the load 90 (or the power required), such that after the duty periods of the switch driving signals SD1 and SD2 are adjusted, the switch driving signals SD1 and SD2 are able to drive the switch units Q1-Q4 in the resonant converting circuit 120 according to changes in the load 90 to thereby obtain an output voltage Vo with a relatively low ripple.

In still other embodiments, selectively adjusting the duty periods and the operating frequencies of the switch driving signals SD1 and SD2 according to the load 90 (or the power required) by the control circuit 140 may include the following step: when the load 90 is somewhat small or smaller than the predetermined level Thr (i.e., the amount of power required by the load 90 is smaller than a predetermined level), through operation of the control circuit 140, fixing the duty periods of the switch driving signals SD1 and SD2, and adjusting the operating frequencies of the switch driving signals SD1 and SD2 according to the curve Curve62 that varies with the load 90 (or the power required), such that after the operating frequencies of the switch driving signals SD1 and SD2 are adjusted, the switch driving signals SD1 and SD2 are able to drive the switch units Q1-Q4 in the resonant converting circuit 120 according to changes in the load 90 to thereby obtain an output voltage Vo with a relatively low ripple.

As shown in FIG. 7, in some embodiments, selectively adjusting the duty periods and the operating frequencies of the switch driving signals SD1 and SD2 according to the load 90 (or the power required) by the control circuit 140 may include the following step: when the load 90 is somewhat large or larger than a predetermined level Thr (i.e., the amount of power required by the load 90 is larger than a predetermined level), through operation of the control circuit 140, adjusting the duty periods of the switch driving signals SD1 and SD2 in a manner corresponding to the curve Curve71, and slightly adjusting the operating frequencies of the switch driving signal SD1 and the switch driving signal SD2 in a manner corresponding to the curve Curve72 according to changes in the load 90 (or the power required). The slope of the curve Curve71 is larger than the slope of the curve Curve72, such that the control circuit 140 mainly adjusts duty period according the curve Curve71 and slightly adjusts operating frequency according to the curve Curve72.

In other embodiments, when the load 90 is somewhat small or smaller than the predetermined level Thr (i.e., the amount of power required by the load 90 is smaller than a predetermined level), according to changes in the load 90 (or the power required), the control circuit 140 adjusts the operating frequencies of the switch driving signals SD1 and SD2 in a manner corresponding to the curve Curve72, and slightly adjusts the duty periods of the switch driving signal SD1 and the switch driving signal SD2 in a manner corresponding to the curve Curve71. The slope of the curve Curve72 is larger than the slope of the curve Curve71, such that the control circuit 140 mainly adjusts operating frequency according the curve Curve72 and slightly adjusts duty period according to the curve Curve71.

In the embodiments described with reference to FIGS. 6 and 7, when the size of the load 90 is approximately equal to the predetermined level Thr (or the power required thereby is approximately equal to the predetermined level Thr), the control circuit 140 adjusts the duty cycles of the switch driving signals SD1 and SD2 to approximately 0.01-0.5. In some embodiment, when the size of the load 90 is approximately equal to the predetermined level Thr (or the power required thereby is approximately equal to the predetermined level Thr), the control circuit 140 adjusts the duty cycles of the switch driving signals SD1 and SD2 to approximately 0.01-0.05. It is noted that the aforementioned predetermined level Thr may be set according to the minimum value of the duty period at the limit of the power system, but the present invention is not limited in this regard.

As is evident from the aforementioned embodiments, through application of the techniques of the prevent invention, the operating frequencies and duty periods of the driving signals are selectively adjusted, such that the method of converting power is able to flexibly satisfy the requirements of different types of loads. Moreover, by adjusting the duty periods of the driving signals, the ripple of the output voltage of the power converter can be made relatively small. As a result, the power quality of an X-ray machine is enhanced, such that the efficiency of an imaging machine is increased, the precision and quality of imaging are improved, and the output of soft rays by an X-ray machine is reduced.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided that fall within the scope of the following claims.

What is claimed is:

1. A power converter comprising:
a resonant converting circuit which converts an input power into an output power, and provides the output power to a load; and
a control circuit which receives a feedback signal corresponding to the output power and the load, and outputs a driving signal according to the feedback signal to drive the resonant converting circuit, wherein the control circuit selectively adjusts a duty period and an operating frequency of the driving signal according to a power required by the load.

2. The power converter of claim 1, wherein the control circuit simultaneously adjusts the duty period and the operating frequency of the driving signal according to changes in the power required by the load.

3. The power converter of claim 1, wherein the control circuit simultaneously adjusts the duty period and the operating frequency of the driving signal in a manner proportional to changes in the power required by the load.

4. The power converter of claim 1, wherein when the amount of power required by the load is larger than a predetermined level, the control circuit fixes the operating frequency of the driving signal and adjusts the duty period of the driving signal according to changes in the power required by the load.

5. The power converter of claim 1, wherein when the amount of power required by the load is smaller than a predetermined level, the control circuit fixes the duty period of the driving signal and adjusts the operating frequency of the driving signal according to changes in the power required by the load.

6. The power converter of claim 1, wherein when the amount of power required by the load is larger than a predetermined level, according to changes in the power required by the load, the control circuit adjusts the duty period of the driving signal and slightly adjusts the operating frequency of the driving signal.

7. The power converter of claim 1, when the amount of power required by the load is smaller than a predetermined level, according to changes in the power required by the load, the control circuit adjusts the operating frequency of the driving signal and slightly adjusts the duty period of the driving signal.

8. The power converter of claim 4, wherein when the amount of power required by the load is approximately equal to a predetermined level, the control circuit adjusts the duty cycle of the driving signal to approximately 0.01-0.05.

9. The power converter of claim 1, wherein when the amount of power required by the load is approximately equal to a predetermined level, the control circuit adjusts the duty cycle of the driving signal to approximately 0.01-0.5.

10. The power converter of claim 1, wherein the control circuit selectively adjusts the duty period and the operating frequency of the driving signal by receiving a feedback voltage signal corresponding to an output voltage generated by the resonant converting circuit or by receiving a feedback current signal corresponding to an output current generated by the resonant converting circuit.

11. The power converter of claim 1, wherein the resonant converting circuit comprises:
at least one switch unit which is controlled by the driving signal to be alternatingly turned on and turned off so as to transmit the input power;
a resonant unit electrically coupled to the at least one switch unit, the resonant unit and the at least one switch unit cooperating to generate an AC power;
an isolation unit electrically coupled to the resonant unit, the isolation unit realizing electrical isolation and transmitting the AC power to output a secondary output power; and
a rectifying unit electrically coupled to the isolation unit, the rectifying unit rectifying the secondary AC power and generating the output power, the rectifying unit transmitting the output power to the load.

12. A method of converting power comprising:
converting, by a resonant converting circuit, an input power into an output power, and providing, by the resonant converting circuit, the output power to a load;
receiving, by a control circuit, a feedback signal corresponding to the output power and the load;
outputting, by the control circuit, a driving signal according to the feedback signal to drive the resonant converting circuit; and
selectively adjusting, by the control circuit, a duty period and an operating frequency of the driving signal according to a power required by the load.

13. The method of converting power of claim 12, wherein selectively adjusting, by the control circuit, the duty period and the operating frequency of the driving signal according to the power required by the load comprises:
simultaneously adjusting the duty period and the operating frequency of the driving signal according to changes in the power required by the load.

14. The method of converting power of claim 12, wherein selectively adjusting, by the control circuit, the duty period and the operating frequency of the driving signal according to the power required by the load comprises:
simultaneously adjusting the duty period and the operating frequency of the driving signal in a manner proportional to changes in the power required by the load.

15. The method of converting power of claim 12, wherein selectively adjusting, by the control circuit, the duty period and the operating frequency of the driving signal according to the power required by the load comprises:
when the amount of power required by the load is larger than a predetermined level, fixing the operating frequency of the driving signal and adjusting the duty period of the driving signal according to changes in the power required by the load.

16. The method of converting power of claim 12, wherein selectively adjusting, by the control circuit, the duty period and the operating frequency of the driving signal according to the power required by the load comprises:
when the amount of power required by the load is smaller than a predetermined level, fixing the duty period of the driving signal and adjusting the operating frequency of the driving signal according to changes in the power required by the load.

17. The method of converting power of claim 12, wherein selectively adjusting, by the control circuit, the duty period and the operating frequency of the driving signal according to the power required by the load comprises:
when the amount of power required by the load is larger than a predetermined level, adjusting the duty period of the driving signal and slightly adjusting the operating frequency of the driving signal according to changes in the power required by the load.

18. The method of converting power of claim 12, wherein selectively adjusting, by the control circuit, the duty period and the operating frequency of the driving signal according to the power required by the load comprises:
when the amount of power required by the load is smaller than a predetermined level, adjusting the operating frequency of the driving signal and slightly adjusting the duty period of the driving signal according to changes in the power required by the load.

19. The method of converting power of claim 12, wherein selectively adjusting, by the control circuit, the duty period and the operating frequency of the driving signal according to the power required by the load comprises:
when the amount of power required by the load is approximately equal to a predetermined level, adjusting the duty cycle of the driving signal to approximately 0.01-0.05.

20. The method of converting power of claim 12, wherein selectively adjusting, by the control circuit, the duty period and the operating frequency of the driving signal according to the power required by the load comprises:
when the amount of power required by the load is approximately equal to a predetermined level, adjusting the duty cycle of the driving signal to approximately 0.01-0.5.

21. The method of converting power of claim 12, wherein receiving, by the control circuit, the feedback signal corresponding to the output power and the load comprises:
receiving a feedback voltage signal corresponding to an output voltage generated by the resonant converting circuit, or receiving a feedback current signal corresponding to an output current generated by the resonant converting circuit.

22. The method of converting power of claim 12, wherein converting, by the resonant converting circuit, the input power into the output power, and providing, by the resonant converting circuit, the output power to the load comprises:
controlling at least one switch unit of the resonant converting circuit according to the driving signal to be alternatingly turned on and turned off so as to transmit the input power;
generating, through cooperation of a resonant unit of the resonant converting circuit and the at least one switch unit, an AC power;
realizing electrical isolation and transmitting the AC power to output a secondary output power by an isolation unit of the resonant converting circuit; and
rectifying the secondary AC power and generating the output power by a rectifying unit of the resonant converting circuit, and transmitting the output power to the load by the rectifying unit.
